(19) United States
(12) Patent Application Publication
(10) Pub. No.: US 2004/0128672 A1
(43) Pub. Date: Jul. 1, 2004

(54) Generic program adapting general algorithm as iteration

(75) Inventor: Derek L. Beatty, Austin, TX (US)

Correspondence Address: David B. Ritchie, THELEN REID & PRIEST LLP, P.O. Box 640640, San Jose, CA, 95164-0640, US

(73) Assignee: Sun Microsystems, Inc., a Delaware Corporation

(21) Appl. No.: 10/319,259

(22) Filed: Dec. 13, 2002

(51) Int. Cl. G06F 9/44

(52) U.S. Cl. 718/102

(57) ABSTRACT

The present invention utilizes a visiting iterator to combine the best characteristics of both generic programming and co-routines. By doing so, coding may still remain fairly simple and utilize less memory, yet state information and other local data may be maintained. This is extremely beneficial when dealing with algorithms which are best designed using iteration, such as traversing tree structures, however, one of ordinary skill in the art will recognize the technique may be applied to any type of algorithm.

### FIELD OF THE INVENTION

The present invention relates to the field of computer programming. More particularly, the present invention relates to a generic program for adapting a general algorithm as iteration.

### BACKGROUND OF THE INVENTION

Normally, when a subroutine in a computer program returns from execution, the execution terminates and the final state the subroutine was in is completely lost. The next time the subroutine is invoked, it commences executing from the initial state. A co-routine, on the other hand, may return a value is such a way that the execution of the routine is suspended, along with all its state information. The next time the routine is invoked, its execution resumes from the statement after the previous point of return. Thus, a co-routine may at any point hand over control to another co-routine. Two or more co-routines may therefore repeatedly call each other and be executed in interleaved fashion. The computer programming language C++ has a co-routine facility in the Posix thread library, which is a commonly used standardization of many Unix functions and utilities.

Generic programming is a kind of program design applicable to object-oriented programming languages and functional programming languages in which parameterized templates are created that can later be instantiated into real classes and algorithms. This allows for programming with families of abstractions that are all related by a common set of requirements. Thus, a programmer may refrain from defining a type in a concrete manner before execution. For example, rather than stating that a variable is of type integer, he may state that a variable is of type t, with t to be defined at a later time. C++ has some support for generic programming through its template mechanism in the C++ Standard Template Library (STL). At compiling time, the compiler may make a note that the template needs to be instantiated in order to define the variable. In addition to variables, data structures may also be used with generic programming. For example, a “pair” may be introduced of one variable type matched with another variable type (e.g., an integer paired with a floating point).

Co-routines may be implemented by using threads. Threads are streams of executions taking place concurrently within the same program, each stream processing a different transaction or message. Iterators may also be used in generic programming. Iterators are similar to pointers, in that they indicate a location in a sequence, which may or may not be in memory. They are used to access a generic collection. For example, a range of elements in an array may be represented by an iterator pointing to the first element and an iterator pointing to the last element.

Generic programming requires a lot less coding and is used extensively for algorithms that require iterations. If generic programming were easily used for traversals, then complex tree structures could be traversed with very little code. However, it is used much less for graph algorithms that require traversal because of the difficulty of maintaining state information between iterations. Without the maintaining of state information, any collection of elements in the tree must be performed after the tree has been built up. But if the set of elements is fairly large (e.g., a large tree), iteration can take up a lot of temporary memory.

What is needed is a solution that allows iteration to be used while maintaining state information between iterations.

### BRIEF DESCRIPTION

The present invention utilizes a visiting iterator to combine the best characteristics of both generic programming and co-routines. By doing so, coding may still remain fairly simple and utilize less memory, yet state information and other local data may be maintained. This is extremely beneficial when dealing with algorithms which are best designed using iteration, such as traversing tree structures, however, one of ordinary skill in the art will recognize the technique may be applied to any type of algorithm.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a diagram illustrating the passing of control from a first co-routine to a second co-routine in accordance with a specific embodiment of the present invention.

FIG. 2 is a flow diagram illustrating a method for performing an algorithm in accordance with a specific embodiment of the present invention.

FIG. 3 is a block diagram illustrating an apparatus for performing an algorithm in accordance with a specific embodiment of the present invention.

### DETAILED DESCRIPTION

Embodiments of the present invention are described herein in the context of a system of computers, servers, and software. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

The present invention utilizes a visiting iterator to combine the best characteristics of both generic programming and co-routines. By doing so, coding may still remain fairly simple and utilize less memory, yet state information and other local data may be maintained. This is extremely beneficial when dealing with algorithms which are best designed using traversal, such as traversing tree structures, however, one of ordinary skill in the art will recognize the technique may be applied to any type of algorithm.

A visiting iterator is a specialized iterator in the sense of the STL. That is, it acts somewhat like a pointer. It can be alternately de-referenced and incremented to give access to a sequence of items. However, the sequence itself need never be constructed and may be represented only implicitly, via an algorithm to generate values of the sequence.

The visiting iterator allows for a reduction in storage of redundant data structures while structuring algorithms in a natural way. For example, Electronic Design Automation (EDA) tools typically utilize large amounts of temporary memory. Consider a simulator which stamps parameters into a matrix. In its most natural form, it iterates over circuit elements and processes their parameter values, hence it should be coded using iteration. However, further consider if one only wants to simulate a subset of the circuit, where the subset is most easily defined by a graph traversal algorithm. The visiting iterator allows the matrix-based portion of the algorithm to be coded using iteration and the graph-based portion of the algorithm to be coded independently, using traversal. Decoupling the two portions of the algorithm results in a much more efficient coding scheme while utilizing less temporary memory.

In a specific embodiment of the present invention, a visiting iterator is structured using a pair of co-routines implemented using a mutex atop a thread mechanism. The use of threads and co-routines may be hidden from clients of the visiting iterator, thus making its performance capabilities transparent to users. A visiting iterator can also be used to generate a lazy sequence, a conceptually infinite sequence whose values will be generated only as they are needed. Additionally, if the algorithm generating the sequence throws an exception, this may be passed on through the visiting iterator.

In a specific embodiment of the present invention, the two threads may be designated as the main thread and the subsidiary thread. The visiting iterator's operation may be understood best by examining the state machine described by a status member, and the way it is manipulated by the two threads. Initially, the main thread sets the status to Starting. When a subsidiary thread runs, it first sets the status to Busy, indicating that it has work to perform. The subsidiary thread then later may set the status to GotValue, then Done. When the main thread sees a status of GotValue, it deals with the value and sets the status back to Busy, indicating that the subsidiary thread can do more work. When the main thread sees Done or Error, it does the appropriate clean up. If the main thread's destructor is invoked before the subsidiary thread has finished, it sets the status to Abort. When the subsidiary thread see this, it thows an exception to terminate the traversal.

Whichever thread is making progress will be holding the mutex. That is, when the main thread enters or returns from one of the iterator methods, it will be holding the mutex. When the subsidiary thread calls a generate values method or other algorithm, or returns from a return value method, it will be holding the mutex.

Once the visiting iterator is constructed, there are several methods that may be performed on it. First, it may be dereferenced. By doing so, the values generated by the co-routine may be returned. Second, it may be incremented. By doing so, the subsidiary thread is executed again, which accomplishes an increment. Third, it may be compared with another value. For example, the iterator could be compared with a variable past-the-end which would indicate the iterator has reached the end of the indicated data structure or portion thereof. Fourth, it could be destroyed. By doing so, the subsidiary thread may be run to clean up, then the subsidiary thread is terminated.

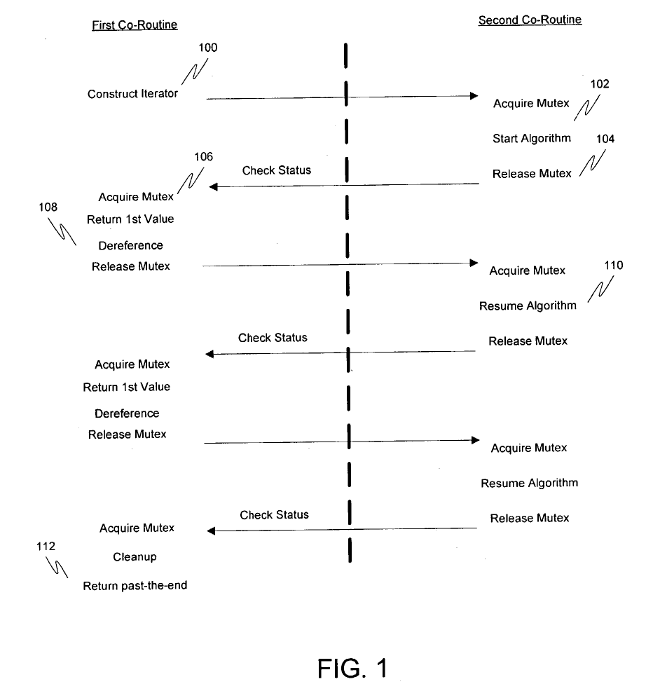

FIG. 1 is a diagram illustrating the passing of control from a first co-routine to a second co-routine in accordance with a specific embodiment of the present invention. At 100, the first co-routine may construct the visiting iterator. It may acquire the mutex first, then release the mutex once it calls the second co-routine. At 102, the second co-routine acquire the mutex and call an algorithm. When a result has been obtained (or an error occurs), the second co-routine may release the mutex at 104 and change the status (to GotValue, Done, or Error). At 106, the first co-routine may check the status and acquire the mutex if it has changed to GotValue, Done, or Error. If it has generated a value, at 108 it may return that value by dereferencing the iterator. Once that has been accomplished, the second-co-routine may be called again the same way as before. This time, however, at 110, the second co-routine resumes where it left off. At 112, the first co-routine may compare the status to a constant indicating that it is past the end, at which point the first co-routine should terminate.

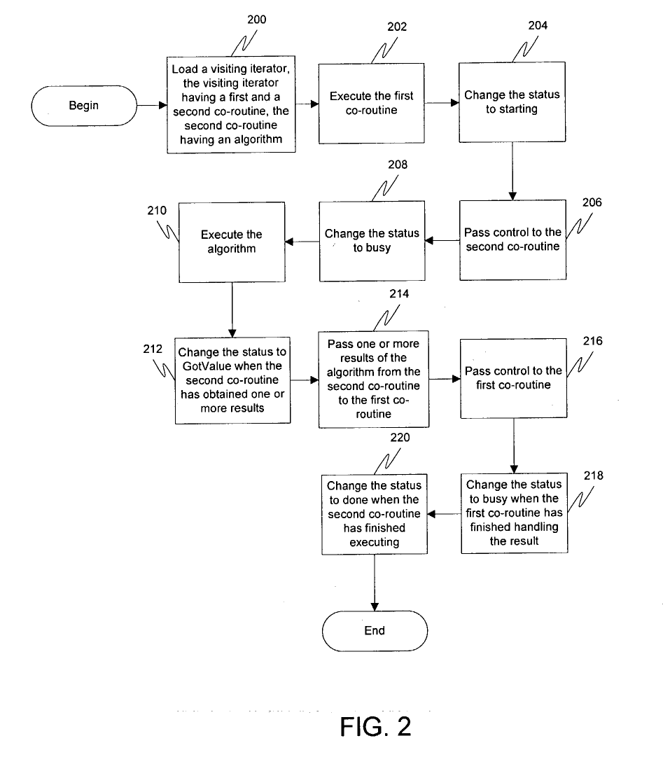

FIG. 2 is a flow diagram illustrating a method for performing an algorithm in accordance with a specific embodiment of the present invention. At 200, a visiting iterator may be loaded, the visiting iterator having a first and a second co-routine, the second co-routine having an algorithm. The visiting iterator may be implemented using generic programming and may be used to generate a lazy sequence. Each of the co-routines may be implemented using a thread. The first co-routine may be the main thread and the second co-routine may be the subsidiary thread. At 202, the first co-routine may be executed. At 204, a status may be changed to starting. At 206, control may be passed to the second co-routine. This may comprise acquiring a mutex. At 208, the status may be changed to busy. At 210, the algorithm may be executed. At 212, the status may be changed to GotValue when the subsidiary thread has obtained one or more results. At 214, one or more results of the algorithm may be passed from the second co-routine to the first co-routine. At 216, control may be passed to the first co-routine. This may comprise acquiring a mutex. At 218, the status may be changed to busy when the first co-routine has finished handling the result. When the subsidiary thread has finished executing, at 220 the status may be changed to done.

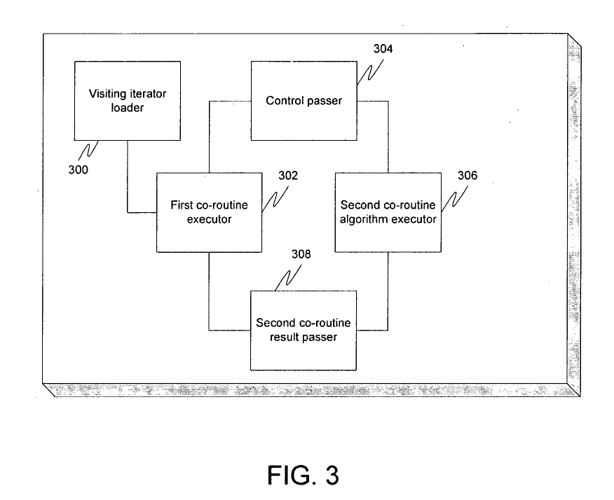

FIG. 3 is a block diagram illustrating an apparatus for performing an algorithm in accordance with a specific embodiment of the present invention. A visiting iterator loader 300 may load a visiting iterator, the visiting iterator having a first and a second co-routine, the second co-routine having an algorithm. The visiting iterator may be implemented using generic programming and may be used to generate a lazy sequence. Each of the co-routines may be implemented using a thread. The first co-routine may be the main thread and the second co-routine may be the subsidiary thread. A first co-routine executor 302 coupled to the visiting iterator loader 300 may execute the first co-routine. A status may then be changed to starting. A control passer 304 coupled to the first co-routine executor may then pass control to the second co-routine. This may comprise acquiring a mutex. Then the status may be changed to busy. A second co-routine algorithm executor 306 coupled to the control passer 304 may execute the algorithm may be executed. The status may be changed to GotValue when the subsidiary thread has obtained one or more results. A second co-routine result passer 308 coupled to the first co-routine executor 302 and to the second co-routine algorithm executor 306 may pass one or more results of the algorithm from the second co-routine to the first co-routine. The control passer 304 may then pass control to the first co-routine. This may comprise acquiring a mutex. The status may be changed to busy when the first co-routine has finished handling the result. When the subsidiary thread has finished executing, the status may be changed to done.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for performing an algorithm, the method comprising:
loading a visiting iterator, said visiting iterator having a first and a second co-routine, said second co-routine having an algorithm;
executing said first co-routine;
passing control to said second co-routine;
executing the algorithm;
passing one or more results of said algorithm from said second co-routine to said first co-routine; and
passing control to said first co-routine.

2. The method of claim 1, wherein each of said co-routines is implemented using a thread.

3. The method of claim 2, wherein said passing control to said second co-routine and said passing control to said first co-routine comprise acquiring a mutex.

4. The method of claim 1, wherein said first co-routine is a main thread and said second co-routine is a subsidiary thread.

5. The method of claim 4, further comprising changing a status to starting when said main thread is initially executed.

6. The method of claim 5, further comprising changing said status to busy when said subsidiary thread is initially executed.

7. The method of claim 6, further comprising changing said status to GotValue when said subsidiary thread has obtained one or more of said one or more results.

8. The method of claim 7, further comprising handling said one or more of said one or more results in a main thread when said status is GotValue.

9. The method of claim 8, further comprising changing said status to busy when said main thread has finished handling said one or more of said one or more results.

10. The method of claim 9, further comprising changing said status to done when said subsidiary thread has finished executing.

11. The method of claim 1, wherein said visiting iterator is implemented using generic programming.

12. The method of claim 1, wherein said visiting iterator may be used to generate a lazy sequence.

13. The method of claim 1, further comprising passing an exception from said second co-routine to said first co-routine if an exception is generated during said executing the algorithm.

14. The method of claim 1, further comprising generating an exception in said second co-routine if said visiting iterator is destroyed.

15. An apparatus for performing an algorithm, the apparatus comprising:
a visiting iterator loader;
a first co-routine executor coupled to said visiting iterator loader;
a control passer coupled to said first co-routine executor;
a second co-routine algorithm executor coupled to said control passer; and
a second co-routine result passer coupled to said first co-routine executor and said second co-routine algorithm executor.

16. An apparatus for performing an algorithm, the apparatus comprising:
means for loading a visiting iterator, said visiting iterator having a first and a second co-routine, said second co-routine having an algorithm;
means for executing said first co-routine;
means for passing control to said second co-routine;
means for executing the algorithm;
means for passing one or more results of said algorithm from said second co-routine to said first co-routine; and
means for passing control to said first co-routine.

17. The apparatus of claim 16, wherein each of said co-routines is implemented using a thread.

18. The apparatus of claim 17, wherein said means for passing control to said second co-routine and said means for passing control to said first co-routine comprise means for acquiring a mutex.

19. The apparatus of claim 16, wherein said first co-routine is a main thread and said second co-routine is a subsidiary thread.

20. The apparatus of claim 19, further comprising means for changing a status to starting when said main thread is initially executed.

21. The apparatus of claim 20, further comprising means for changing said status to busy when said subsidiary thread is initially executed.

22. The apparatus of claim 21, further comprising means for changing said status to GotValue when said subsidiary thread has obtained one or more of said one or more results.

23. The apparatus of claim 22, further comprising means for handling said one or more of said one or more results in a main thread when said status is GotValue.

24. The apparatus of claim 23, further comprising means for changing said status to busy when said main thread has finished handling said one or more of said one or more results.

25. The apparatus of claim 24, further comprising means for changing said status to done when said subsidiary thread has finished executing.

26. The apparatus of claim 16, wherein said visiting iterator is implemented using generic programming.

27. The apparatus of claim 16, wherein said visiting iterator may be used to generate a lazy sequence.

28. The apparatus of claim 16, further comprising means for passing an exception from said second co-routine to said first co-routine if an exception is generated during said executing the algorithm.

29. The method of claim 16, further comprising means for generating an exception in said second co-routine if said visiting iterator is destroyed.

30. A program storage device readable by a machine, tangibly embodying a program of instructions executable by the machine to perform a method for performing an algorithm, the method comprising:
loading a visiting iterator, said visiting iterator having a first and a second co-routine, said second co-routine having an algorithm;
executing said first co-routine;
passing control to said second co-routine;
executing the algorithm;
passing one or more results of said algorithm from said second co-routine to said first co-routine; and
passing control to said first co-routine.
